(19) United States
(12) Patent Application Publication
(10) Pub. No.: US 2010/0277598 A1
(43) Pub. Date: Nov. 4, 2010

(54) METHOD AND APPARATUS FOR CAPTURING ANTI-ALIASING DIRECTX MULTIMEDIA CONTENTS MOVING PICTURE

(75) Inventor: David Bosik Kim, Seoul (KR)

Correspondence Address: HOLME ROBERTS & OWEN LLP, 1700 LINCOLN STREET, SUITE 4100, DENVER, CO, 80203, US

(73) Assignee: MWSTORY Co., Ltd., Seoul (KR)

(21) Appl. No.: 12/570,086

(22) Filed: Sep. 30, 2009

(30) Foreign Application Priority Data
Apr. 29, 2009 (KR) 10-2009-0037874

(51) Int. Cl. H04N 5/225

(52) U.S. Cl. 348/207.1; 348/E05.024

(57) ABSTRACT

Disclosed is a method for capturing a directX moving picture. The method consists of (a) allowing the control unit to generate a multisampled rendertarget surface of a moving picture using an anti-aliasing technique for a capturing target moving picture of the directX multimedia contents in a buffer; (b) allowing the control unit to detect the capturing target moving picture using the anti-aliasing technique, which is provided in a back-buffer by executing the directX multimedia contents and copy and temporarily store the detected capturing target moving picture to and in the multisampled rendertarget surface; (c) allowing the control unit to output the temporarily stored capturing target moving picture on the basis of an FIFO method when the capturing target moving picture is stored in the multisampled rendertarget surface at a reference value or higher; and (d) allowing the control unit to convert and store the output capturing target moving picture.

### BACKGROUND OF THE INVENTION

This application claims priority to Korean Patent Application No. 10-2009-0037874, filed on Apr. 29, 2009, in the Korean Intellectual Property Office, the entire contents of which are hereby incorporated by reference.

1. Field of the Invention

The present invention relates to a method and an apparatus for capturing a high-quality directX moving picture, and more particularly, to a method and an apparatus for capturing a directX moving picture for capturing one scene of a moving picture using a general or high-quality technique of directX as a still picture and storing the scene as a picture file.

2. Description of the Related Art

In recent years, most of multimedia contents such as a moving picture player or a game, which computer users have been interested in, have been developed using a directX technique. In the case of the moving picture outputted by using the directX technique, when a capturing command of a graphic device interface (GDI) is inputted by using a print screen key provided on a keyboard for capturing a general still picture, no moving picture is captured.

In general, since a windows moving picture player shows most of moving pictures displayed on a screen by using general directX, a directX contents screen can be captured even by a general method and when the screen is technologically stored by using a back-buffer of the directX, rapid performance can be acquired.

However, a high-quality directX moving picture such as the game other than a moving picture produced by the directX can be produced by using the following two capturing techniques.

A first method uses a multisampled technique which is one of anti-aliasing techniques in order to remove aliasing of one screen moving picture for capturing in a high-quality directX moving picture such as a game. However, restrictions apply for capturing a directX game moving picture. That is, the back-buffer of the directX cannot be used in the moving picture adopting the multisampled technique and when a front-buffer is adopted, the execution performance (load) of a computer deteriorates by twice or more. Therefore, since the moving picture cannot be generated by locking the back-buffer adopting the anti-aliasing, the moving picture should be stored by capturing the back-buffer through a multisampled off-screen (other temporary storage space). However, since the computer slows down due to the load, the multisampled off-screen cannot be used. As a result, capturing is executed by generating a general moving picture off-screen in which only a multisampled function is removed for improving the performance of the computer. Information on the performance of the computer using the first method is shown in FIG. 5.

A second method includes a method of capturing the moving picture by using the front-buffer or capturing the moving picture by calling ‘D3DXSaveSurfaceToFile’ which is an application for capturing the directX contents moving picture provided by a directX program with respect to the moving picture generated by using the multisampled technique as a result of analyzing a known capturing method. However, there is found that this method remarkably deteriorates the performance of the computer through experimentation. Information on the performance of the computer using the second method is shown in FIG. 5. Therefore, in the case of capturing the directX multimedia contents (particularly, a high-end game) moving picture, a method to capture a high-quality screen moving picture while minimizing a load to a user's computer environment is required.

FIG. 1 is a diagram illustrating an example in which one scene of an execution moving picture of multimedia contents produced by a directX technique is displayed on a screen.

The displayed moving picture shows a moving picture displayed on the screen as the high-end game is executed among the high-quality multimedia contents produced by the directX anti-aliasing technique.

FIG. 2 is a diagram illustrating a resulting moving picture capturing and storing the multimedia contents moving picture using the directX anti-aliasing of FIG. 1 by the known method.

As shown in the figure, when the multimedia contents moving picture using the directX anti-aliasing is captured and stored by the known method, a background screen is displayed black-colored and as a result, capturing is failed.

By the known method, even though the general directX multimedia contents moving picture can be captured, an execution speed decreases due to a load to the computer and the captured moving picture is not normally stored at the time of capturing the directX multimedia contents moving picture using the high-quality anti-aliasing.

### SUMMARY OF THE INVENTION

Accordingly, the present invention proposes to solve the above-mentioned problems. It is an object of the present invention to provide a method and an apparatus for capturing an anti-aliasing directX multimedia content moving picture that can more rapidly capture and store an execution moving picture of multimedia contents using a general or high-quality anti-aliasing technique, which are produced by a directX technique while minimizing the load of a user's computer.

In order to achieve the above objects, there is a provided a method for capturing a directX multimedia contents moving picture which is executed through a computer by a control unit which is provided in the computer and controls execution of directX multimedia contents comprising: (a) allowing the control unit to generate a multisampled rendertarget surface of a moving picture using an anti-aliasing technique for a capturing target moving picture of the directX multimedia contents in a buffer when a capturing command of the directX multimedia contents moving picture which is being executed is inputted; (b) allowing the control unit to detect the capturing target moving picture using the anti-aliasing technique, which is provided in a back-buffer by executing the directX multimedia contents and copy and temporarily store the detected capturing target moving picture to and in the multisampled rendertarget surface; (c) allowing the control unit to output the temporarily stored capturing target moving picture on the basis of an FIFO method when the capturing target moving picture is stored in the multisampled rendertarget surface at a reference value or higher; and (d) allowing the control unit to convert and store the outputted capturing target moving picture as an image file of predetermined format.

Preferably, in the step (a), the multisampled rendertarget surface is generated by using a ‘CreateRenderTarget’ function included in a directX program included in the directX multimedia contents.

Preferably, in the step (b), the capturing target moving picture is detected by using a ‘StretchRect’ function included in the directX program, and copied to and temporarily stored in the multisampled rendertarget surface.

Preferably, in the step (d), the outputted capturing target moving picture is stored as the image file by using a ‘D3DXSaveToFile’ function included in the directX program.

In one embodiment of the present invention, as the capturing command of the directX multimedia contents moving picture is inputted, a time when the capturing target moving picture of the directX multimedia contents is captured and stored is in the range of 400 to 600 ms.

In order to achieve the above objects, there is provided an apparatus for capturing a directX multimedia contents moving picture which is executed through a computer comprising: a temporary space generation unit that generates a multisampled rendertarget surface for a capturing target moving picture of the directX multimedia contents in a buffer in accordance with the input of a capturing command of the directX multimedia contents moving picture using an anti-aliasing technique which is being executed; a copy unit that detects the capturing target moving picture using the anti-aliasing technique in a back-buffer by executing the directX multimedia contents, and copies and temporarily stores the detected capturing target moving picture to and in the multisampled rendertarget surface; an output unit that outputs the temporarily stored a capturing target moving picture on the basis of an FIFO method when the capturing target moving picture is stored in the multisampled rendertarget surface at a predetermined reference value or higher; and a capture working thread that converts and stores the outputted capturing target moving picture as an image file of predetermined format.

Preferably, the temporary space generation unit generates the multisampled rendertarget surface by using a ‘CreateRenderTarget’ function included in a directX program included in the directX multimedia contents.

Preferably, the copy unit detects the capturing target moving picture by using a ‘StretchRect’ function included in the directX program, and copies and temporarily stores to and in the multisampled rendertarget surface.

Preferably, the capture working thread stores the outputted capturing target as the image file by using a ‘D3DXSaveToFile’ function included in the directX program.

According to an embodiment of the present invention, it is possible to prevent the performance of a computer from deteriorating and an executing screen from being cut and to acquire a moving picture with more clear picture quality at the time of capturing a multimedia contents moving picture using an anti-aliasing technique by detecting and temporarily storing a moving picture using the anti-aliasing technique, which will be sequentially captured through a buffer for consecutive capturing commands and storing the temporarily stored moving picture in a capture working thread as an image file in accordance with an FIFO method.

### BRIEF DESCRIPTION OF THE DRAWINGS

These and other objects, features, aspects, and advantages of the present invention will be more fully described in the following detailed description of preferred embodiments and examples, taken in conjunction with the accompanying drawings. In the drawings:

FIG. 1 is a diagram illustrating an example in which one scene of an execution moving picture of multimedia contents produced by a directX anti-aliasing technique is displayed on a screen;

FIG. 2 is a diagram illustrating a resulting moving picture capturing and storing the directX multimedia contents moving picture using the directX anti-aliasing of FIG. 1 by the known method;

FIG. 3 is a block diagram illustrating an apparatus for capturing a directX multimedia contents moving picture using an anti-aliasing technique according to one embodiment of the present invention;

FIG. 4 is a diagram illustrating a resulting moving picture capturing a moving picture of FIG. 1 by using an apparatus for capturing a directX multimedia contents moving picture of FIG. 3;

FIG. 5 is a diagram illustrating capturing performance through the present invention and the known method for a directX multimedia contents moving picture; and

FIG. 6 is a flowchart illustrating a method for capturing a directX multimedia contents moving picture using an anti-aliasing technique according to one embodiment of the present invention.

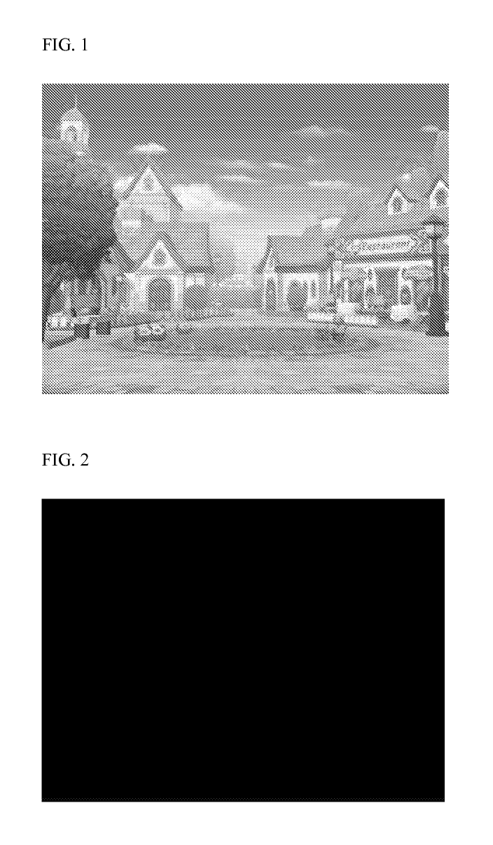

### DETAILED DESCRIPTION OF THE INVENTION

Hereinafter, preferred embodiments of the present invention will be described in detail with reference to the accompanying drawings. It should be noted that like reference numerals refer to like components throughout the drawings. In addition, the detailed description of a related known function or configuration that may make the purpose of the present invention unnecessarily ambiguous in describing the present invention will be omitted.

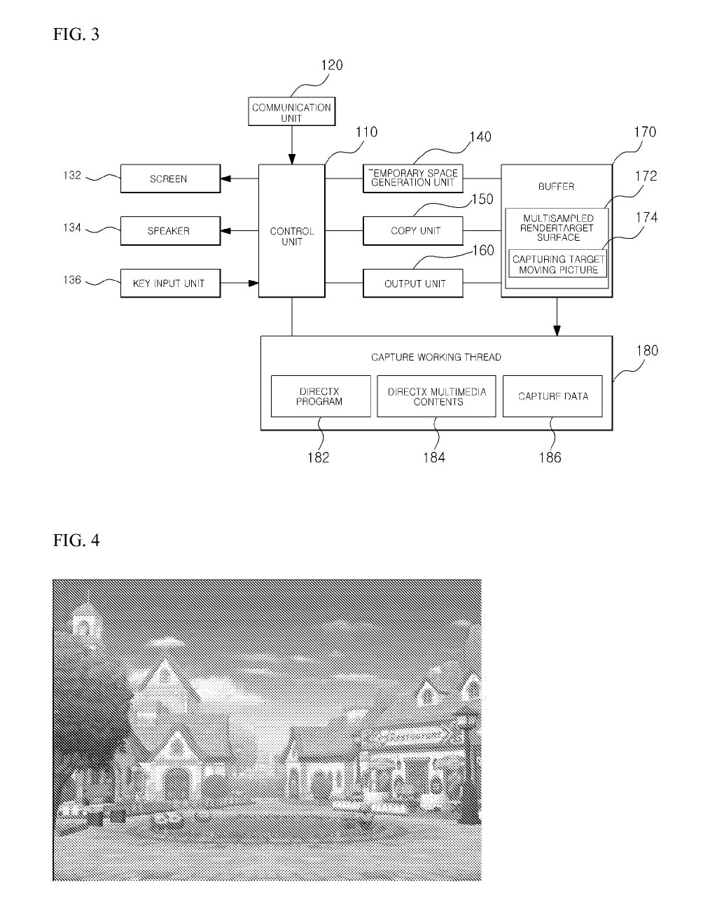

FIG. 3 is a block diagram illustrating an apparatus for capturing a directX multimedia contents moving picture using an anti-aliasing technique according to one embodiment of the present invention.

As shown in the figure, the apparatus for capturing a directX multimedia contents moving picture is configured to include a control unit 110, a communication unit 120, a screen 132, a speaker 134, a key input unit 136, a temporary space generating unit 140, a copy unit 150, an output unit 160, a buffer 170, and a capture working thread 180.

The control unit 110 controls a general operation of the apparatus for capturing the directX multimedia contents moving picture and controls an operation required to capture a contents moving picture using an anti-aliasing technique which is being executed according to one embodiment of the present invention.

The communication unit 120 transmits and receives the directX multimedia contents through an online communication network such as the Internet.

Information on an execution result of the directX multimedia contents provided through the online communication network in accordance with the control of the control unit 110 is displayed on the screen 132. Further, a capturing resulting moving picture of the directX multimedia contents moving picture which is being executed according to the embodiment of the present invention is displayed on the screen 132.

The speaker 134 outputs audio information generated in accordance with an execution result of the directX multimedia contents.

The key input unit 136 is provided with keys for executing the directX multimedia contents and inputting the capturing command for moving pictures displayed in accordance with the execution result.

The temporary space generating unit 140 generates a multisampled rendertarget surface at the time of capturing the directX multimedia contents moving picture using the anti-aliasing technique by using a ‘CreateRenderTarget’ function included in the directX program included in the contents. The ‘CreateRenderTarget’ function is a function for creating a temporary storage space at the time of capturing a moving picture (target) to be drawn on the screen by executing the directX multimedia contents using the anti-aliasing technique. The multisampled rendertarget surface is provided in the buffer 170.

The copy unit 150 detects a capturing target moving picture 174 to be drawn on the screen using the anti-aliasing technique in a back-buffer by executing the contents by means of a ‘StretchRect’ function included in the directX program included in the contents, and copies and temporarily stores the detected moving picture to and in a multisampled rendertarget surface 172.

When a moving picture to be drawn on the screen is temporarily stored in the multisampled rendertarget Surface 172 at a predetermined level or higher, the output unit 160 outputs the capturing target moving picture 174 to be drawn on the screen temporarily stored in the multisampled rendertarget surface 172 to a capture working thread 180 on the basis of an FIFO method in accordance with a temporary storage time.

In this embodiment, the buffer 170 is provided with the multisampled rendertarget surface 172 for storing the moving picture to be drawn on the screen in order to capture the moving picture as the directX multimedia contents are executed. At this time, the capturing target moving picture 174 is temporarily stored in the buffer 170 and is outputted to the capture working thread 180 on the basis of the FIFO method.

When the capturing target moving picture 174 which is the moving picture to be drawn on the screen stored in the multisampled rendertarget surface 172 is inputted, the capture working thread 180 stores the capturing target moving picture 174 inputted by using a‘D3DXSaveToFile’ function included in the directX as an image file such as a PNG or JPG format. In this embodiment, the capture working thread 180 stores and manages capture data 186 in which the directX program 182 for executing the contents, the directX multimedia contents 184, and the capturing target moving picture 174 are inputted and stored as the image file.

As such, in the present invention, it is possible to prevent the performance of a computer from deteriorating and an executing screen from being cut and to acquire a moving picture with more clear picture quality at the time of capturing a multimedia contents moving picture using an anti-aliasing technique by detecting and temporarily storing a moving picture using the anti-aliasing technique, which will be sequentially captured through the buffer 170 for continuous capturing commands and storing the temporarily stored moving picture in a capture working thread 180 as an image file in accordance with an FIFO method.

FIG. 4 is a diagram illustrating a resulting moving picture capturing a moving picture using an anti-aliasing technique of FIG. 1 by using an apparatus for capturing a directX multimedia contents moving picture of FIG. 3.

As shown in the figure, when the contents moving picture (see FIG. 1) which is being executed is captured through the apparatus for capturing the directX multimedia contents moving picture of the present invention, it is possible to capture a moving picture having the same picture quality.

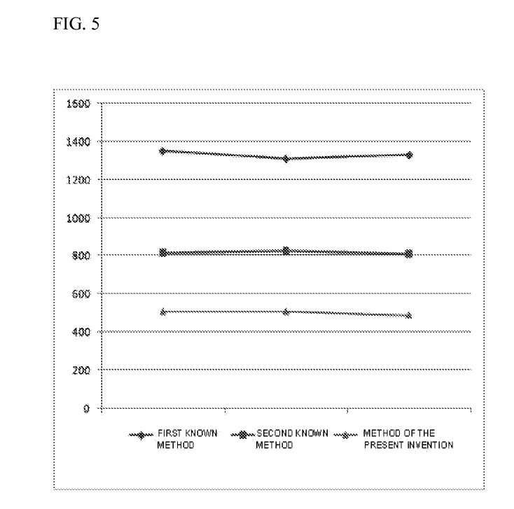

FIG. 5 is a diagram illustrating capturing performance through the present invention and the known method for a directX multimedia contents moving picture.

As shown in the figure, in the first known method for capturing the directX contents moving picture, it can be found that a time of 1200 to 1400 ms per time is consumed as a result of executing three-times capturing and in the second known method, it can be found that a time of 800 to 900 ms per time is consumed as a result of executing three-times capturing.

On the contrary, as shown in the figure, when the directX contents moving picture is captured three times by using the apparatus for capturing the directX multimedia contents moving picture of the present invention, it can be found that a time of 400 to 600 ms per time is consumed.

As such, the apparatus for capturing the directX contents moving picture of the present invention has an advantage of more rapidly capturing and storing an execution moving picture of the multimedia contents produced by the directX technique while minimizing the load of a user's computer.

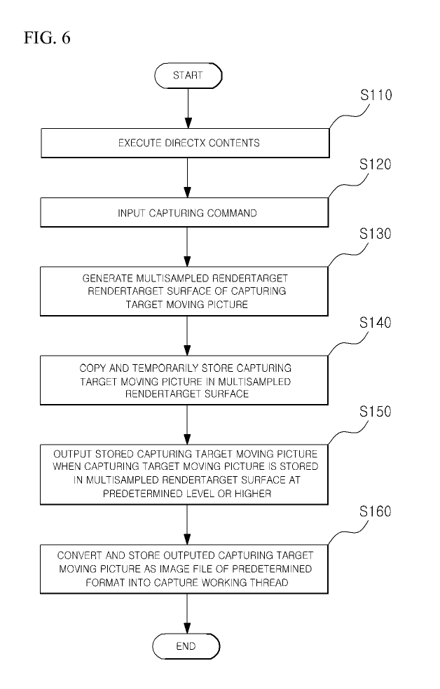

FIG. 6 is a flowchart illustrating a method for capturing a directX multimedia contents moving picture according to one embodiment of the present invention.

First, the control unit 110 executes the directX multimedia contents 184 using the anti-aliasing technique, which is stored in the capture working thread 180 in accordance with a contents execution command inputted from the key input unit 136 (S110). At this time, the control unit 110 outputs moving picture and audio information in accordance with the execution result of the directX multimedia contents 184 through the screen 132 and the speaker 134.

When a command to capture the moving picture of the directX multimedia contents 184 which is being executed is inputted from the key input unit 136 (S120), the control unit 110 controls the temporary space generation unit 140 to generate the multisampled rendertarget surface 172 for temporarily storing the moving picture to be displayed, which uses the anti-aliasing technique at the time of capturing the directX multimedia contents moving picture by using the ‘CreateRenderTarget’ function included in the directX program included in the directX multimedia contents in the buffer 170 (S130).

After the control unit 110 generates the multisampled rendertarget surface 172 in the buffer 170, the control unit 110 controls the copy unit 150 to detect the moving picture to be drawn on the screen in the back-buffer by executing the directX multimedia contents by using the ‘StretchRect’ function included in the directX program included in the directX multimedia contents and copy and temporarily store the detected moving picture to and in the multisampled rendertarget surface 172 (S140).

When the capturing target moving picture 174 to be drawn on the screen is copied to and temporarily stored in the multisampled rendertarget surface 172, the control unit 110 controls the output unit 160 to output the stored capturing target moving picture 174 to be drawn on the screen temporarily stored in the multisampled rendertarget surface 172 to the capture working thread 180 on the basis of the FIFO method in accordance with a temporary storage time when the capturing target moving picture 174 to be drawn on the screen is temporarily stored in the multisampled rendertarget surface 172 at a predetermined level or higher (S150).

When the temporarily stored capturing target moving picture 174 is outputted from the multisampled rendertarget surface 172 to the capture working thread 180, the control unit 110 controls the capture working thread 180 to convert and store the outputted capturing target moving picture 174 from the multisampled rendertarget surface 172 as the image file of predetermined format by using the ‘D3DXSaveToFile’ function included in the directX (S160).

According to the present invention, it is possible to prevent the performance of a computer from deteriorating and an executing screen which is being executed from being cut and to acquire a moving picture with more clear picture quality at the time of capturing a directX multimedia contents moving picture with high quality.

While the present invention has been described with reference to the preferred embodiments, it will be understood by those skilled in the related art that various modifications and variations may be made therein without departing from the scope of the present invention as defined by the appended claims.

What is claimed is:

1. A method for capturing a directX multimedia contents moving picture which is executed through a computer by a control unit which is provided in a computer and controls execution of the directX multimedia contents comprising:
(a) allowing the control unit to generate a multisampled rendertarget surface of a moving picture using an anti-aliasing technique for a capturing target moving picture of the directX multimedia contents in a buffer when a capturing command of the directX multimedia contents moving picture which is being executed is inputted;
(b) allowing the control unit to detect the capturing target moving picture using the anti-aliasing technique, which is provided in a back-buffer by executing the directX multimedia contents and copy and temporarily store a detected capturing target moving picture to and in the multisampled rendertarget surface;
(c) allowing the control unit to output a temporarily stored capturing target moving picture on a basis of an FIFO method when the capturing target moving picture is stored in the multisampled rendertarget surface at a reference value or higher; and
(d) allowing the control unit to convert and store an outputted capturing target moving picture as an image file of predetermined format.

2. The method for capturing a directX multimedia contents moving picture wherein, in step (a) of claim 1, the multisampled rendertarget surface is generated by using a ‘CreateRenderTarget’ function included in a directX program included in the directX multimedia contents.

3. The method for capturing a directX multimedia contents moving picture wherein, in step (b) of claim 1, the capturing target moving picture is detected by using a ‘StretchRect’ function included in a directX program, and copied to and temporarily stored in the multisampled rendertarget surface.

4. The method for capturing a directX multimedia contents moving picture wherein, in step (d) of claim 1, the outputted capturing target moving picture is stored as the image file by using a ‘D3DXSaveToFile’ function included in a directX program.

5. The method for capturing a directX multimedia contents moving picture according to claim 1, wherein, as the capturing command of the directX multimedia contents moving picture is inputted, a time when the capturing target moving picture of the directX multimedia contents is captured and stored is in a range of 400 to 600 ms.

6. An apparatus for capturing a directX multimedia contents moving picture which is executed through a computer comprising:
a temporary space generation unit that generates a multisampled rendertarget surface for a capturing target moving picture of the directX multimedia contents in a buffer in accordance with an input of a capturing command of the directX multimedia contents moving picture using an anti-aliasing technique which is being executed;
a copy unit that detects the capturing target moving picture using the anti-aliasing technique in a back-buffer by executing the directX multimedia contents, and copies and temporarily stores a detected capturing target moving picture to and in the multisampled rendertarget surface;
an output unit that outputs the temporarily stored a capturing target moving picture on a basis of an FIFO method when the capturing target moving picture is stored in the multisampled rendertarget surface at a predetermined reference value or higher; and
a capture working thread that converts and stores an outputted capturing target moving picture as an image file of predetermined format.

7. The apparatus for capturing a directX multimedia contents moving picture according to claim 6, wherein the temporary space generation unit generates the multisampled rendertarget surface by using a ‘CreateRenderTarget’ function included in a directX program included in the directX multimedia contents.

8. The apparatus for capturing a directX multimedia contents moving picture according to claim 6, wherein the copy unit detects the capturing target moving picture by using a ‘StretchRect’ function included in a directX program, and copies and temporarily stores to and in the multisampled rendertarget surface.

9. The apparatus for capturing a directX multimedia contents moving picture according to claim 6, wherein the capture working thread stores the outputted capturing target as the image file by using a ‘D3DXSaveToFile’ function included in a directX program.
